(19) United States
(12) Patent Application Publication
(10) Pub. No.: US 2005/0240122 A1
(43) Pub. Date: Oct. 27, 2005

(54) Device for tactile stimulation

(76) Inventors: Terence William Gander, Berkshire (GB); Brian Gough, Middlesex (GB); Colin Kemp, Hampshire (GB); Chris Parrati, Englefield Green (GB); Elizabeth Paul, Harrogate (GB); Alan Riley, Ceridigion (GB)

Correspondence Address: NIXON & VANDERHYE, PC, 901 NORTH GLEBE ROAD, 11TH FLOOR, ARLINGTON, VA, 22203, US

(21) Appl. No.: 10/502,298

(22) PCT Filed: Sep. 25, 2003
(86) PCT No.: PCT/GB03/04073

§ 371 Date: Jun. 17, 2005

(30) Foreign Application Priority Data
Sep. 28, 2002 (GB) 0222559.7

(51) Int. Cl. A61H 1/02

(52) U.S. Cl. 601/1

(57) ABSTRACT

A device for applying a tactile stimulus, comprising a finger sleeve with one or more raised elements on its outer surface, wherein there is at least one raised element or part thereof in that region of the sleeve defined by the first 15% of its overall length measured from its distal end, and wherein the raised element(s) are arranged in a loop surrounding a blank region of the sleeve which carries no raised elements. The raised element(s) may define a fluid retaining region on the sleeve surface. A region of the sleeve may have a greater flexibility than that of the rest of the sleeve, so as to provide variability in circumference. The device is of particular use in the treatment of female orgasmic disorders and may be used to apply a fluid substance as well as a tactile stimulus.

The present invention relates to a device for use in applying a tactile stimulus, in particular to the body.

The device may for instance be used to stimulate sensitive tissue areas such as erectile tissue and in particular the clitoris, and hence is especially suitable for use in the treatment of the syndrome known as female orgasmic disorder.

WO-02/39945 describes an applicator/stimulator device which may be used in the treatment of female orgasmic disorder (there referred to as female sexual arousal disorder), and which facilitates the manual application, to the genital area, of a tactile stimulus together with a lubricant fluid and/or a pharmaceutically active substance such as a vasodilator. The device of WO-02/39945 takes the form of a flexible finger sleeve having one or more fluid-containing cells and optionally also projections to provide additional tactile stimulation. The fluid cell(s) are preferably sealed before use, but rupture under pressure to release the fluid.

U.S. Pat. No. 5,819,765 discloses gloves and finger sleeves of use in applying active substances to areas within the oral cavity. These devices carry sealed hollow members which are designed to release an active substance on application of pressure for instance by rubbing the device against the teeth or gums.

The present invention provides alternative forms of such finger-worn devices, which again may be used to apply a tactile stimulus and optionally also to deliver fluid(s) and/or other substance(s) to the stimulated area.

According to a first aspect of the present invention there is provided a device of use in applying a tactile stimulus, the device comprising a sleeve adapted to accommodate a finger, and one or more raised elements on the outer surface of the sleeve, the device being further characterised by one or more of the following features:
a) at least one of the raised elements, or a part of a raised element, is located in that region of the sleeve defined by the first 15% of its overall length measured from the distal end of the sleeve.
b) the raised element(s) are arranged on the outer sleeve surface in a closed loop, preferably in the shape of an ellipse, circle, oval, “lozenge” or rounded-end rectangle.
c) the raised element(s) are arranged on the sleeve surface in a loop surrounding a blank region of the sleeve surface which carries no raised elements.
d) the raised element(s) at least partly define a fluid retaining region on the outer sleeve surface.
e) at least one region of the sleeve has a greater flexibility than that of the rest of the sleeve, preferably so as to provide variability in the size (in particular the circumference) of the sleeve.
f) the sleeve has a tearable portion defined at least partly by a region of reduced sleeve strength.
g) the sleeve is provided with a vent to facilitate the release of air from within during fitting.

The device preferably incorporates more than one, more preferably two or three or more and ideally all, of these features. A particularly preferred embodiment incorporates at least features (a) and (c), preferably in combination with feature (b) and/or feature (d). Another preferred embodiment incorporates at least features (a) and (d). Still another preferred embodiment incorporates at least feature (e), preferably in combination with (a) and/or (c) and/or (d) and conveniently in combination with feature (f).

In this specification, the terms “distal end” and “proximal end” refer to the in-use device, the distal end thus being that which in use will house the free end of the wearer's finger.

The word “finger” is intended also to include a thumb, and typically refers to a human digit, either male or female.

A device according to the invention allows the manual application of a tactile stimulus and can be, as described above, of particular use in the treatment of female orgasmic disorder. It will typically be designed for a single use and to be disposable after use.

The sleeve which forms the basis of the device is preferably at least partly, more preferably wholly, made from a flexible and/or elastic material such as a natural or synthetic rubber or plastics material. Suitable materials include polyurethane, polypropylene, silicon and thermoplastic elastomers, preferably the latter. A suitable hardness for this material is Shore A, for instance from 20 or 25 to 55 or 60°, more typically from 25 or 30 to 35 or 40 or 45°, such as about 30° (eg, from 28 to 32°, ideally from 28 to 30°). Ideally the material is thicker and less flexible than a typical male condom, to an extent sufficient to retain an approximately finger-shaped structure unsupported, yet is sufficiently flexible to allow the device to fit comfortably around the wearer's finger and to flex with the finger in use. It is ideally also sufficiently thin as to allow the user to retain at least a degree of tactile sensitivity, particularly in the region corresponding, in use, to the underside finger tip, and/or in the region where the raised element(s) are located.

Because of its intended use, the sleeve is preferably made from a non-toxic, more preferably pharmaceutical grade, material.

The sleeve may for instance be of the general form described in WO-02/39945. Preferably it will be closed at its distal end, and it will typically have an approximately circular transverse cross section.

Plastics or rubber sleeves may be produced for instance by injection or dip moulding or by injection blow moulding or by casting. Such processes may also be used to achieve the desired profiling of the sleeve surface, including the provision of raised element(s) and if desired indented fluid cells as described below.

The size and shape of the sleeve may depend on those of the finger(s) it is intended to accommodate. A typical length, for instance for a European or North American user, might be from 40 to 80 mm, more suitably from 45 to 75 mm. In cases the sleeve may be long enough to accommodate only the tip of the wearer's finger, ie, the finger end region bounded by the distal finger joint, in which case a suitable sleeve length might be from 25 to 35 mm, more suitably from 25 to 30 mm.

The length of the sleeve may vary around its circumference, being for example longer at that face corresponding in use to the underside (palm side) of the wearer's finger—at its longest the sleeve might suitably be from 60 to 85 mm, preferably from 65 to 80 mm or from 70 to 75 mm in length, and at its shortest (corresponding typically to the upper side or back of the wearer's finger) from 35 to 60 mm, preferably from 40 to 55 mm, more preferably from 45 to 55 mm in length. Such lengths may be measured from the far distal end of the sleeve, suitably along its outer surface. Alternatively they may be measured along the central longitudinal sleeve axis. References in this specification to percentages of overall sleeve length may be taken to relate to the length at the longest part of the sleeve, or to the length at the side (typically the underside) where the raised element(s) are located.

A suitable sleeve circumference may vary along the sleeve length, being suitably greater (for instance from 49 or 50 to 65 or 71 mm, preferably from 55 to 60 mm) at the position corresponding to the wearer's proximal finger joint and smaller (for instance from 40 to 55 or 60 mm, preferably from 45 to 53 mm) at the distal joint position. It may taper to a yet smaller value closer to and at the distal end of the sleeve. These figures are for a European/North American population and may vary for other populations.

Unless otherwise stated, sleeve dimensions quoted in this specification relate to the sleeve in its unflexed state, ie, prior to use on a wearer's finger. Smaller dimensions may be appropriate for instance for South East Asian and other user groups.

The sleeve may be constructed to allow variability in size, for instance as described below in connection with feature (e). It may be capable of accommodating more than one finger. It may be shaped at its distal end to accommodate a finger nail, or otherwise profiled to increase the wearer's comfort, to improve fit and/or to enhance its aesthetic appearance.

The raised element(s) of the device help to provide tactile stimulation during use. By “raised element” is meant an element which protrudes above the outer surface of the sleeve, typically in a direction substantially perpendicular to that of the longitudinal sleeve axis and/or to the plane of the outer sleeve surface at the relevant point.

The number, size, shape and location of the raised element(s) will depend on the intended use of the device, for instance the nature and degree of stimulation it is intended to provide and the aesthetic qualities required of it. There may for instance be a single raised element, appropriately sized and shaped and located. Alternatively there may be a plurality of raised elements, for instance two or more, typically more than two, preferably six or more, more preferably from six to ten, most preferably eight. The raised element(s) are conveniently located at or near the distal end of the sleeve.

In accordance with feature (b) above, the raised element(s) are preferably arranged in a loop, more preferably a rounded (ie, non-angular) loop, yet more preferably in the shape of an ellipse, circle, oval, “lozenge” or rounded-end rectangle as opposed to in a linear or angular (eg, classically rectangular) array. This can help provide the advantages discussed below in connection with features (c) and (d), as well as improving the device aesthetically. The diameter of the loop may for instance range from 10 to 30 mm, more suitably from 15 to 30 mm; where the loop is elongate, these figures typically relate to the longest dimension. The loop may be formed from a plurality of individual raised elements, or for instance by a single continuous raised element in the shape of a loop.

At least some, and ideally all, of the raised element(s) are preferably located in a specific region of the device which corresponds, in use, to the underside of the wearer's finger end and which will therefore provide the primary region of tactile stimulation. This “finger tip” region, typically bounded by the wearer's distal finger joint, generally represents the most sensitive and controllable area of the finger.

Ideally, according to feature (a) above, at least one raised element or part thereof is located in that region of the sleeve surface defined by the first 15%, preferably the first 14 or 13 or 12 or 11 or even 10%, ofthe overall sleeve length measured from its distal end. There is preferably more than one, most preferably 2 or 3 or more, raised elements in the defined region of the sleeve. However where the sleeve carries only one raised element, it may be preferred for at least 4%, more preferably at least 5 or 6%, of the volume of that element (by which is meant the volume which protrudes beyond the outer sleeve surface) to be located in the defined region.

Typically the defined distal end region, containing the at least one raised element or part thereof, will occupy a length of from 5 to 15 mm, more typically from 6 to 12 or from 7 to 10 mm, measured from the distal end of the sleeve.

In cases, in particular where the sleeve length is such as to accommodate less than the full finger length (eg, only the tip of the wearer's finger), it may be suitable for a device according to the invention to have at least one raised element or part thereof in that region of the sleeve defined by the first 16% or 17% or 8% or 20% or 22% or 25% or 28% or 30% of the overall sleeve length, measured from the distal end. There may then be at least 2, preferably 3 raised elements or parts thereof in the region defined by the first 20% or 22% or 25% or 26% or 30% or 35% or 40% of the overall length. In any case the raised element(s) are again preferably all located in the above defined finger tip region in use.

It may be preferable for there to be no raised elements at the far distal end of the sleeve, for instance within the first 3 or 4 or even 5% of the overall length or within 2 or 3 or 4 mm of the distal sleeve end. In particular it may be preferable for there to be no raised elements extending beyond the distal end such as in a direction generally parallel to that of the longitudinal sleeve axis.

In the region defined by the first 25% of the overall sleeve length (measured from its distal end) there are preferably at least 3, more preferably at least 4 or 5, raised elements.

In the region defined by the first 40% of the overall length there are preferably at least 5, more preferably at least 6 or 7, raised elements.

Ideally all, or most (for instance, 70 or 80% or more), of the raised element(s) are located in the above described “finger tip” region, typically within that region of the sleeve surface defined by the first 50%, more preferably the first 45 or 42%, of the overall sleeve length measured from its distal end.

Conveniently there will be no raised elements in that region of the sleeve extending beyond the first 55% or even the first 50 or 45 or 42% of the overall sleeve length measured from its distal end, at least on the underside (palm side) of the sleeve in use. Suitably there are raised element(s) only in the region (again, at least on the palm side of the sleeve in use) which corresponds to the wearer's finger tip, ie, the distal region bounded by the wearer's distal finger joint—this region may occupy a length of for instance from 25 to 40 mm, typically from 28 to 35 mm, such as of about 30 mm, measured from the distal end of the sleeve. Leaving the proximal end of the sleeve free of raised elements on its underside can improve flexibility and comfort during use, in particular leaving the regions corresponding to the wearer's proximal and preferably also distal finger joints free to flex, and ideally also avoiding undesired contact with regions of the body not intended to be stimulated.

A preferred form of raised element takes the form of a dome-like projection or nodule, of approximately spherical shape or being at least hemispherical at its free end. Its height, above the sleeve surface, may be from 3 to 6 or 7 mm, preferably from 4 or 4.5 to 5 mm. Its diameter, at the sleeve surface, may be from 2.5 or 3 to 5 mm, preferably from 4 to 4.5 mm.

Where there are two or more raised elements, they may all have the same size and shape or they may differ, and they may be equally or unequally spaced. A typical spacing between raised elements, at the sleeve surface, might be from 2 to 6 mm or from 2 to 5.5 mm, such as about 4 mm—this may mean a spacing between the centres of raised elements (measured for instance at their free ends) of from 4 to 10 mm, preferably from 5 to 10 mm.

The raised element(s) are conveniently formed as part of the sleeve wall, for instance during the moulding of the sleeve. Alternatively they may be produced separately and secured to the outer sleeve surface, for example by means of an adhesive, by welding or via a secondary substrate which carries the raised element(s) and is itself then secured to the sleeve surface.

In accordance with feature (c) above, the raised element(s) preferably define a blank region of the sleeve surface which carries no raised elements. More preferably, the arrangement of raised elements comprises two groups each of at least one and preferably two or more raised elements, the two groups being positioned to either side of the blank region. These two groups of raised element(s) are preferably spaced apart circumferentially around the sleeve surface by the blank region.

The blank region is preferably located so that, in use, it corresponds to the central region of the palm side of the wearer's finger tip. It is preferably at least 4 mm, more preferably at least 5 or 6 mm wide (ie, around the sleeve circumference, typically between the two groups of raised element(s)), for instance up to 7 or 8 or 9 mm wide. This may correspond to a width of at least 7% of the sleeve circumference at that point, preferably at least 8 or 10%, such as up to 15 or 20 or 25%.

The blank region may be bounded at either or both of its longitudinal ends by one or more raised elements. If bounded at both ends, its length (measured in a direction parallel to the longitudinal sleeve axis, and inside the defining raised elements) may be from 10 to 25 mm, preferably from 12 to 23 mm, such as from 15 to 22 mm, suitably about 19 mm. Its length may therefore correspond to from 10 to 65% of the overall sleeve length, preferably from 20 to 50% or from 20 to 30%. It preferably extends from a point which is within the first 15%, ideally the first 14 or 13 or 12 or 11 or even 10%, of the overall sleeve length measured from the distal end of the sleeve.

Where there are two groups of raised element(s) which define the blank region between them, each may comprise a row of raised elements, for instance running parallel or approximately parallel to the longitudinal sleeve axis. Each group may comprise two or more, preferably three or more, raised elements. Alternatively a “group” may consist of a single raised element, for instance of elongate form to mimic a row of individual elements.

Thus the blank region may for example have an approximately rectangular shape, ideally with rounded ends, or a “lozenge” shape, or an approximately oval or elliptical or circular shape, bounded by raised elements. It is preferably surrounded by a loop of raised elements, the two “groups” of raised elements constituting two sides of the loop.

Such arrangements of raised elements, providing a blank region on the sleeve surface, can be particularly advantageous when the device of the invention is to be used to apply a tactile stimulus to the clitoris, more particularly when treating female orgasmic disorder. Whilst the raised elements to either side of the blank region can be used to stimulate the clitoral shaft and the regions immediately surrounding the clitoris, the clitoris itself, which is often highly sensitive and in some patients (for instance, menopausal women) painfully so, can be protected from undue direct stimulation. The raised elements are ideally arranged so that, in use, they can surround but suitably not contact the tip of the clitoris.

Moreover the provision of two groups of raised elements, for instance in two spaced apart rows, can in use simulate, using only one finger, the tactile stimuli which would ordinarily require use of two fingers, thus enhancing the effectiveness of the device.

According to feature (d) above, the raised element(s) may not only provide tactile stimulation but also serve to define a trap which, when the device is used to apply a fluid substance such as a lubricant or a pharmaceutically active substance, helps to retain that substance in the region to which it is intended to be applied, thus reducing wastage and enhancing ease of use. By “fluid retaining region” is meant a region in which a quantity of fluid, such as a lubricant or an active substance-containing fluid, may be at least partially trapped, at least when the device is held in an approximately horizontal orientation with its raised element(s) uppermost.

The fluid retaining region should be defined at least partly by the raised element(s) on the sleeve, and preferably takes the form of an open-topped enclosure bound by the raised element(s) and the outer sleeve surface; in other words, the fluid retaining region may be completely defined by the raised element(s) (ideally 2 or 3 or 5 or more of them, more preferably all of them) and the outer sleeve surface. The sleeve surface in the fluid retaining region is conveniently substantially flat as opposed to for instance recessed or indented, and may be such that in the absence of the raised element(s) it would not serve to trap fluid at all.

Preferably the fluid retaining region occupies the entire area within a loop formed by the raised element(s). A preferred arrangement of raised element(s) is therefore one which encircles the fluid retaining region, for instance in the approximate shape of an ellipse, circle, oval, “lozenge” or rounded-end rectangle. The fluid retaining region may be the same as, or correspond at least partly with, a blank region of the sleeve surface provided in accordance with preferred feature (c) above.

A single raised element in the form of a closed loop may serve to define the fluid retaining region within its perimeter. Alternatively two or more the raised elements may be close enough together to inhibit, ideally prevent, the escape of fluid from a region they surround. As a yet further alternative there may be secondary raised element(s), typically protruding less far above the sleeve surface, positioned between primary raised elements so that the primary and secondary elements together define a continuous fluid retaining wall. The height of such secondary raised elements, above the sleeve surface, might suitably be from 1 to 2 mm, such as from 1.2 to 1.5 mm.

The raised element(s) may be of a greater rigidity than the main body of the sleeve, to aid the provision of tactile stimulation. This may for example be achieved, if the raised element(s) are to be formed in the sleeve wall, by increasing the thickness of the sleeve at the raised element(s), or more preferably by moulding the raised element(s) as solid or substantially solid (as opposed to hollow) elements.

One or more, preferably all, of the raised elements may however be made more flexible, depending on user requirements, by forming them from a less rigid and/or thinner material and/or by compromising their structural integrity in some way. For example, they may be at least partially hollow or they may be cut away or split for example at their free ends. A hollow raised element may simply comprise a concave or otherwise recessed region, such as a cut out channel, conveniently either at its free (outer) end or at its base where it meets the sleeve surface, or it may comprise a hollow channel running through the element for instance from its free end to its base.

Again, not all raised elements on the device need have the same structure or rigidity.

In a device according to the invention which incorporates feature (e) above, one region of the sleeve should have a greater flexibility than that of the main body of the sleeve. This allows some variability in the sleeve size and hence in the size of finger which it can comfortably accommodate. The higher flexibility region is preferably more stretchable than the main sleeve body when being fitted over a user's finger, and preferably thereby allows an increase in the sleeve circumference; it is suitably oriented longitudinally with respect to the main sleeve body, but allowing stretching in the circumferential direction.

The higher flexibility region is typically formed from a higher flexibility material than that of the adjacent sleeve body. Conveniently the higher flexibility region is formed from the same material as that of the rest of the sleeve, but with a lower thickness—this may be achieved by injection moulding for instance. In this case the higher flexibility region might typically have a thickness of from 15 to 40% of that of adjacent sleeve regions.

The higher flexibility region may instead be formed from a different material altogether to that of the main sleeve body. It may be formed from a corrugated, crimped or otherwise profiled material which is more able to stretch than the main sleeve body. The material of the higher flexibility region may be perforated (for example, provided with elongate cuts) to facilitate its expansion under strain—such perforations may be incorporated for example during moulding, or subsequently for example by stamping.

As a yet further alternative, the higher flexibility region may be provided in the form of a hole or slit or other break in the sleeve body, optionally bounded by for instance a circumferentially extending strap of a flexible material.

Preferably the higher flexibility region is provided at or near the side of the wearer's finger when in use. More preferably, it has an elongate shape orientated substantially in the direction of the finger. It may for instance extend from the proximal end of the sleeve but may terminate short of the distal sleeve end. Its length may be from 50 to 90%, more preferably from 60 to 80%, of that of the overall sleeve.

The circumferential (with respect to the overall sleeve) width of the higher flexibility region may be from 5 to 50% of the sleeve circumference at the relevant point along the sleeve, preferably from 5 to 30%, more preferably from 8 to 25%. This width may vary along the length of the higher flexibility region, for example being from 20 to 50% (or even up to 80%) of the sleeve circumference at the proximal end of the sleeve but narrower towards the distal end. It may for example be from 10 to 20 mm, although it may be as low as 5 or even 3 mm.

The device may comprise two or more higher flexibility sleeve regions at appropriate locations, for instance spaced radially around the sleeve. This can further improve its size variability. Most preferably, there are two higher flexibility regions, ideally one corresponding to each side of the wearer's finger in use.

To facilitate its removal after use, and ideally also to prevent or at least discourage re-use, the device of the invention may comprise a tearable portion which may be torn away, either partially or completely, from the rest of the sleeve. According to feature (f) above, this portion may be defined at least partly by a region of reduced sleeve strength, along which the sleeve will tear, and/or where a tear can originate, on application of an appropriate force. The region of reduced sleeve strength may be formed by a boundary between two sleeve regions of differing flexibility, thickness and/or strength.

In a particularly preferred embodiment, the tearable sleeve portion is formed as a higher strength (typically, higher thickness) region of the sleeve between two lower strength (typically lower thickness) regions, its “tear-lines” representing the boundaries between regions of differing strengths.

Alternatively the reduced strength region may take the form of scoring or perforations in the sleeve, or of a region formed from a reduced strength (conveniently, reduced thickness) material adjacent the tearable sleeve portion.

A reduced strength region conveniently extends in a longitudinal or approximately longitudinal direction, ie, it is orientated substantially in the direction of the finger in use. It may however extend around the circumference of the sleeve, for instance allowing the distal end of the sleeve to be torn away from the remainder when pulled in the longitudinal direction. It may, at a point where it meets an open edge of the sleeve, terminate in a cut or notch or other break in the sleeve fabric.

Suitably the device has at least two reduced strength regions, radially spaced around the sleeve.

Ideally once a tearable sleeve portion has been torn away, the rest of the sleeve will no longer fit accurately around the wearer's finger, thus rendering the device effectively a single-use product.

Where the device of the invention is provided with a vent, according to feature (g) above, this may take the form of an aperture in the sleeve, conveniently at or towards its distal end. The aperture may for instance be a circular hole, or an elongate or cross-shaped slit. Alternatively the sleeve wall may incorporate a channel through which air may be vented during fitting onto a wearer's finger; this may for example be provided through one of the raised elements. A vent is of particular value if the sleeve is closed at its distal end.

A vent may be incorporated either during production of the sleeve, for instance by moulding, or subsequently for instance by machining.

The device of the invention may be used to apply substances to an area of stimulation, typical examples being lubricants and pharmaceutically active substances, in particular those which may be of use in the treatment of female orgasmic disorder such as vasoactive compounds (eg, vasodilators), nerve stimulants and anti-irritants. Thus, the device may be for use as an applicator as well as a stimulator.

In its simplest mode of use, the desired substance is applied to the device from an external source, before the device is brought into contact with the treatment area. The device may be packaged in combination with such a substance, preferably with instructions for their use together.

However, the device may itself be adapted to deliver a desired substance. It may for instance incorporate one or more cells which contain the substance and which are adapted to release it during use—typical examples are the fluid-containing cells described in WO-02/39945 in which a fluid is retained by a seal which is preferably openable or rupturable when pressure is applied across it and/or when the seal is in contact with an environment (for instance, a particular temperature or pH) which weakens it. Such cells are ideally defined in the sleeve wall, for instance as indentations, again as described in WO-02/39945, and are preferably located with or in the immediate vicinity of the raised element(s) which provide the tactile stimulation. One or more of the raised elements may also function as a fluid-releasing cell.

The substance may be contained in such cells in any appropriate form such as a solution, suspension, cream, paste or gel.

The device of the invention may contain inside the main sleeve body, or carry on the outer sleeve surface, a substance such as a lubricant (in particular a silicone-based lubricant, although many other suitable types are commonly available), a pharmaceutical active (in particular a vasodilator) or an aroma containing substance (particularly an aroma based on human pheromones). The material from which the sleeve is made may itself be coated with a lubricating substance, for instance a silicone-based or other lubricant of the type often used on the surfaces of male condoms. Such lubricant coatings can be applied for instance by spraying.

Generally a device according to the invention may be used to apply a tactile stimulus (optionally together with a substance such as a lubricant) to any area of a patient's body in need thereof, and hence to treat any condition which requires for its alleviation or cure the application of such a tactile stimulus to a part of the body. The device may also be used for non-therapeutic, eg, cosmetic, purposes, including for instance to apply tactile pressure to any surface not necessarily on a living body.

A second aspect of the present invention provides the use of a device according to the first aspect, to apply tactile stimulation for instance to the body, and/or to apply a substance, in particular a fluid, to a surface in particular to living tissue.

The present invention also provides the use of a device according to the first aspect, in the treatment of female orgasmic disorder or a related condition. It further provides a method of treating female orgasmic disorder or a related condition, which comprises applying a tactile stimulus to the genital area of a patient using a device according to the first aspect of the invention, and optionally also applying, using the device, a lubricant and/or an active substance to the stimulated area.

The condition being treated may be any condition the symptoms of which include inability to attain, or consistently to attain, orgasm, or slowness to attain orgasm, or failure to attain a sufficiently satisfying orgasm.

Still further the invention provides a device according to the first aspect, for use in the treatment of a medical condition, in particular female orgasmic disorder or a related condition.

The present invention will now be described by way of example only and with reference to the accompanying illustrative drawings, of which:

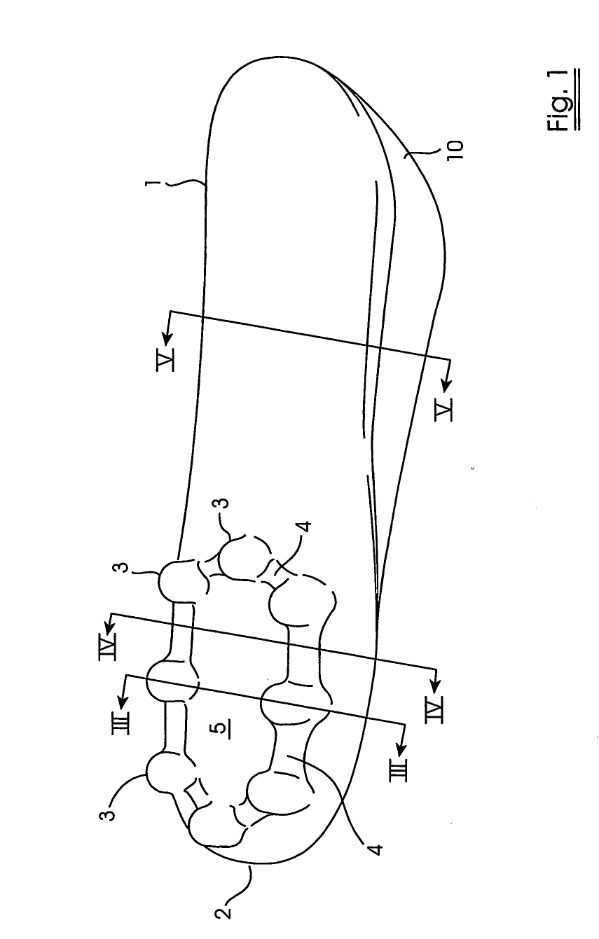

FIG. 1 is a perspective view of a device according to the invention, from below (underside);

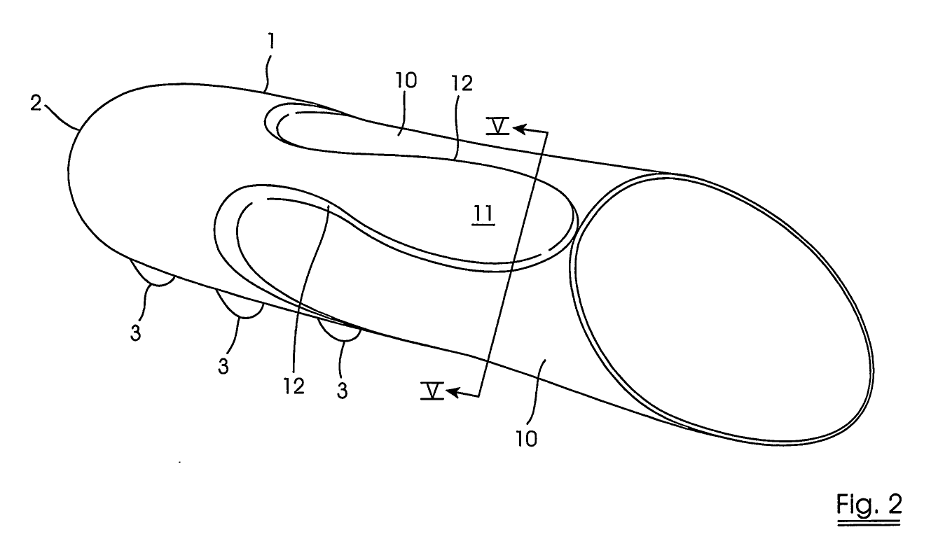

FIG. 2 is a perspective view of the FIG. 1 device, seen from above;

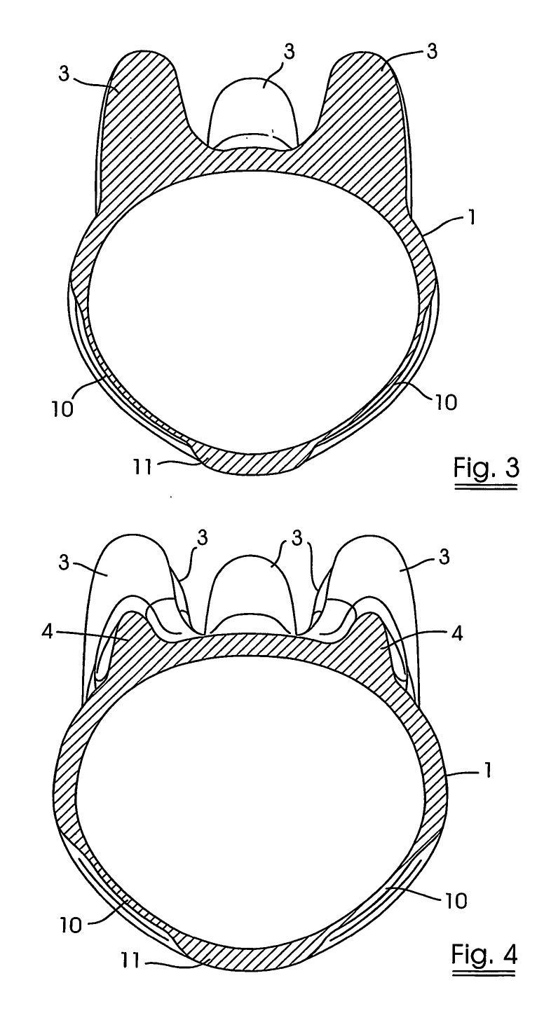

FIG. 3 is a section taken along the line III-III in FIG. 1;

FIG. 4 is a section taken along the line IV-IV in FIG. 1;

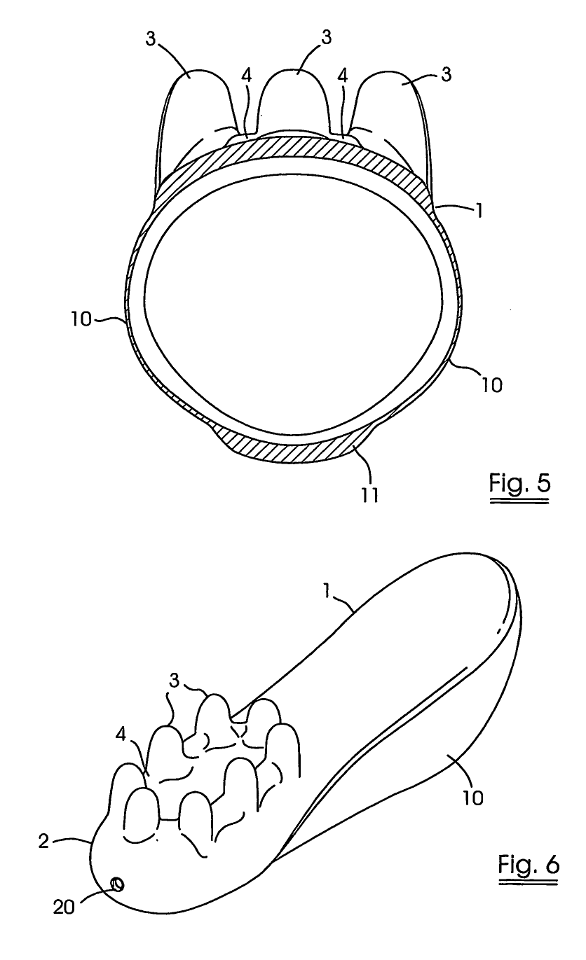

FIG. 5 is a section taken along the line V-V in FIGS. 1 and 2;

FIG. 6 is a perspective view of an alternative device according to the invention;

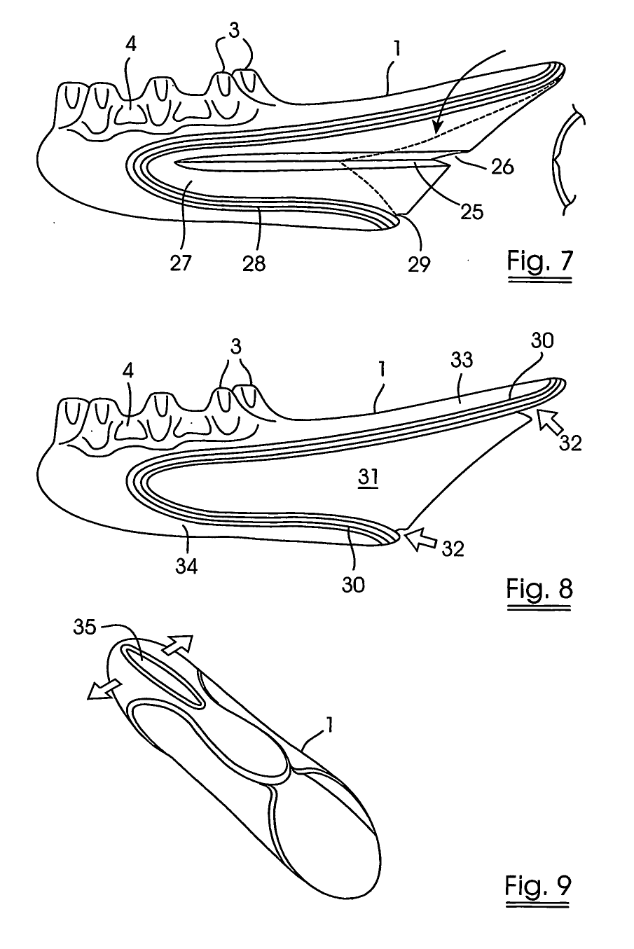

FIGS. 7 and 8 are side views of further alternative devices according to the invention;

FIG. 9 is a perspective view from above of a yet further alternative device according to the invention;

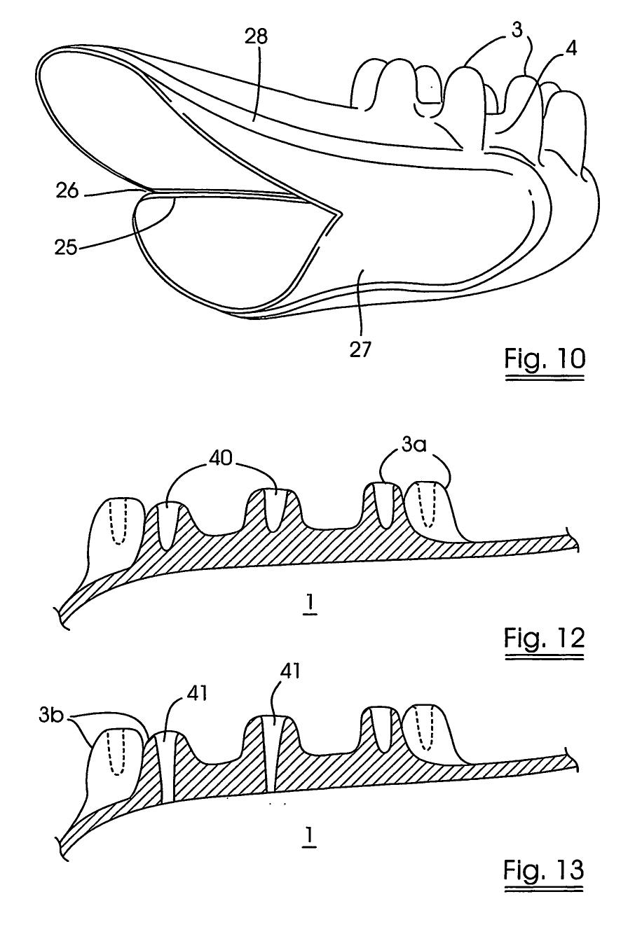

FIG. 10 is a perspective view from the rear and one side of a device similar to that of FIG. 7;

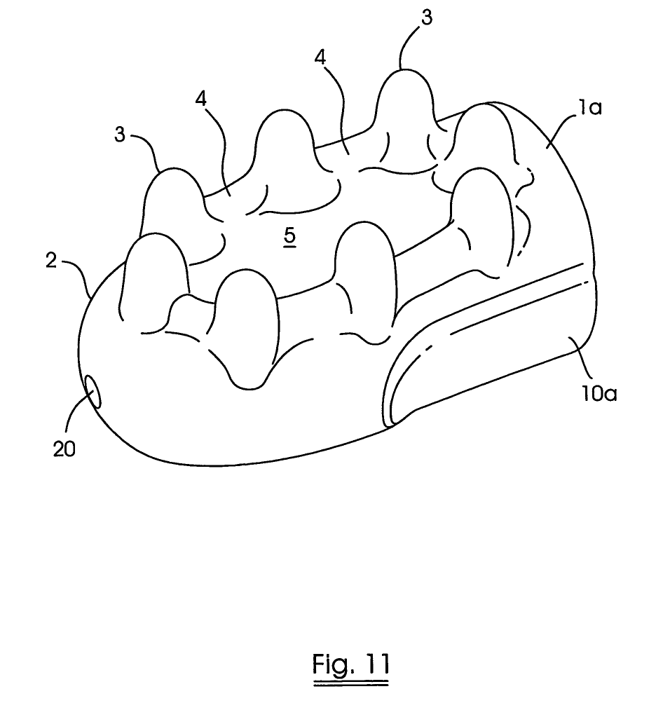

FIG. 11 is a perspective view from below of another alternative device according to the invention; and

FIGS. 12 and 13 are longitudinal sections through parts of further alternative devices according to the invention.

All figures are schematic.

Referring firstly to FIG. 1, the stimulator device shown comprises a finger-shaped sleeve 1 made from a resilient injection moulded thermoplastic elastomer (hardness about 30° Shore A). Its dimensions are such as to accommodate a typical human middle finger.

The sleeve has a closed distal end generally labelled 2, close to which is provided (on the underside of the device) a series of eight projections 3 arranged in an oval or approximately oval shaped loop. These projections are approximately hemispherical at their free ends. They are formed during the moulding process and are solid, as can be seen in FIG. 3, which imparts greater rigidity and enhances the tactile stimulation they provide.

It can be seen from FIGS. 1 and 4 that between each pair of projections 3 there is a secondary raised portion 4, also formed during injection moulding. The projections and the secondary portions 4 together define a continuous approximately oval wall which acts as a fluid trap labelled 5 in FIG. 1. Thus if the device is used with, or more specifically used to apply, a fluid such as a lubricant, at least some of the fluid is likely to be retained in the desired area of application, ie, in the region of the projections 3 which provide the tactile stimulation.

In an alternative version of the FIG. 1 device, the projections 3 may be filled with a substance, ideally in fluid form, which is to be applied during use. In this case, to allow release of the fluid at the appropriate time, the outer walls of the projections may be made from a material (for instance, a thin polyurethane) which is rupturable under pressure, or the projections may be open-ended and covered with a subsequently rupturable seal to contain the fluid within them.

Instead or in addition, the device may be provided with one or more fluid-containing cells separate from the projections 3.

FIG. 2 shows that part of the device which in use will correspond to the upper side (back) of the wearer's finger. Two elongate panels 10 can be seen which are formed from a thinner plastic than that of the rest of the sleeve and whose positions correspond roughly to the sides of the wearer's finger. The reduced thickness panels 10 flank a tear-away panel 11, which has the form of a readily graspable tab.

Following use of the device, the wearer can pull the panel 11 backwards (ie, generally towards the finger ends) to cause it to tear away from the rest of the sleeve along the boundary line 12 between the different thickness panels. This facilitates removal of the sleeve, and also encourages its disposal after use, as might in the context be appropriate.

Panels 10 and 11 can be formed, each to its desired thickness, during injection moulding of the sleeve 1. In the device of FIGS. 1 to 5, for example, the main body of the sleeve and the tear-away panel 11 might have a thickness of around 1 mm, whereas the side panels 10 might be between 0.2 and 0.4 mm, such as about 0.35 mm, thick. The main sleeve body may be thinner than 1 mm in the finger tip region around the projections 3.

In the device of FIGS. 1 to 5, the height of the projections 3 above the sleeve 1 (measured from the centre of the projection area) might typically be 4.81 mm, that of the intermediate raised portions 4 approximately 1.4 mm. The diameter of the projections (measured at their base, ie, at the sleeve surface) might typically be 4.2 mm. The oval defined by the eight projections might have an approximate length of 28 mm and width of 15 mm, these being the outside dimensions, ie, between the outer edges of the defining projections.

The length of the sleeve 1 conveniently ranges from approximately 72.5 mm (at the underside face seen in FIG. 1) to approximately 49 mm (at the upper face seen in FIG. 2). Its circumference is suitably about 49 mm at the position corresponding to the wearer's distal finger joint and about 58 mm at the position corresponding to the proximal joint. The sleeve dimensions may however vary depending on the group of users for which it is intended.

The alternative devices shown in FIGS. 6 to 9 are essentially the same as that of FIGS. 1 to 5 and like parts carry the same reference numerals.

The FIG. 6 device is provided, at its distal end, with a vent hole 20 to ease its fitting onto a user's finger. Such a vent hole (which might alternatively take the form of a small slit in the sleeve fabric) could be provided at any alternative position, for instance within the fluid trap region 5 for convenience of moulding.

Each of the devices of FIGS. 7 and 10 has a reduced strength tear line 25 running in a longitudinal direction from its proximal towards its distal end, in a position corresponding in use to the side of the wearer's finger. At its free end the tear line terminates in an approximately V-shaped notch 26 provided in the sleeve fabric, allowing the user more readily to locate and to grasp hold of tearable portions of the sleeve. At its opposite end it terminates at the boundary 28 between different thickness sleeve panels.

The tear line is formed during the moulding process from a reduced thickness of the sleeve fabric, as shown in the section to the right hand side of FIG. 7. In this case the line might have a thickness of from 0.08 to 0.15 mm, such as approximately 0.1 to 0.12 mm. A second corresponding tear line (not shown) may be provided on the opposite side of the sleeve. After use, the wearer may pull either the top or the bottom portion of the sleeve to cause it to tear from the notch(es) 26, partly or wholly along the reduced thickness line(s) and optionally also in other directions across the reduced thickness side panel 27 (similar to the panels 10 in the FIG. 1 device), thereby facilitating sleeve removal.

The boundary lines 28 between the reduced thickness panels 27 and the rest of the sleeve also represent potential tear lines, and may be provided with cut-out notches such as 29 at their free ends, to assist the user in grasping relevant parts of the sleeve in order to remove it after use.

The dashed line 25a in FIG. 7 indicates a further alternative location for a reduced thickness tear line.

Another “tear-off” option for a device similar to those of FIGS. 7 and 10 is illustrated in FIG. 8. Here the two boundaries 30 between the reduced thickness side panel 31 and the rest of the sleeve constitute tear lines of reduced strength, again provided with V-shaped notches 32 at their free ends. A corresponding reduced thickness panel is provided on the other side of the device. After use, the wearer may grasp either the top portion 33 or the bottom portion 34 of the sleeve, and pull it in a direction towards the finger end to cause it to tear along the lines 30.

The FIG. 9 device comprises a higher flexibility section 35 in the region corresponding, in use, to the top side of the wearer's finger tip. This section is again formed during the moulding process by reducing the thickness of the thermoplastic material, and provides a degree of expansion in the sleeve circumference, as shown by the arrows, at the crucial finger tip region, in turn allowing the sleeve comfortably to accommodate a range of finger sizes. The region 35 could alternatively take the form of a cut-out portion, ie, a gap in the sleeve fabric.

The device shown in FIG. 11 differs from those of FIGS. 1 to 10 in that its sleeve la accommodates, in use, only the tip of the wearer's finger, ie, the end region bounded by the distal finger joint. Nevertheless it carries raised elements 3 and 4 of the same type and in the same arrangement as for instance the FIG. 1 device, towards the distal end 2 of the sleeve, and in use they will occupy the same positions with respect to the wearer's finger tip and serve the same function. Again the raised elements define a fluid trap 5.

The FIG. 11 device also has reduced thickness side panels 10a analogous to those of the FIG. 1 device, and an air vent 20 as in the FIG. 6 device.

Each of FIGS. 12 and 13 shows part of the distal end region of a device according to the invention. They illustrate how, in a device such as those of FIGS. 1 to 11, the projections 3 may instead of being solid be at least partially hollow so as to reduce their rigidity. Those of the FIG. 12 device, labelled 3a, have channels 40 cut into their free ends. These can help to trap a fluid, such as a lubricant, which the device is being used to apply.

In the projections 3b of the FIG. 13 device, some channels 41 extend through from the free ends of the projections to the inside of the sleeve. Such channels can additionally function as vents to aid the release of air from the sleeve during fitting.

Devices such as those of FIGS. 1 to 11 can be used to apply a tactile stimulus in the clitoral area of a female patient. In so doing the projections 3 contact primarily the two sides of the clitoral shaft, thus providing what has been found to be highly effective and satisfying stimulation whilst protecting the more sensitive tip of the clitoris from excessive contact. When, as intended, a lubricant is also applied using the device, it will tend to accumulate in the fluid trap region 5 and thus be retained in the clitoral area again to protect sensitive tissue during stimulation.

1. A device of use in applying a tactile stimulus, the device comprising a sleeve adapted to accommodate a finger and one or more raised elements on the outer surface of the sleeve, wherein there is at least one raised element or part of a raised element in that region of the sleeve defined by the first 15% of its overall length measured from its distal end, and wherein the raised element(s) are arranged in a loop surrounding a blank region of the sleeve surface which carries no raised elements.

2. A device according to claim 1, comprising from six to ten raised elements on the outer sleeve surface.

3. A device according to claim 1, wherein the raised elements are arranged on the outer sleeve surface in the shape or approximate shape of an oval.

4. A device according to claim 1, wherein the raised element(s) are located in that region of the device which in use corresponds to the underside of the wearer's finger tip.

5. A device according to claim 1, wherein there is at least one raised element in that region of the sleeve surface defined by the first 10% of the overall sleeve length measured from its distal end.

6. A device according to claim 1, wherein all of the raised element(s) are located within that region of the underside sleeve surface defined by the first 50% of the overall sleeve length measured from its distal end.

7. A device according to claim 1, wherein the raised element(s) take the form of dome-like projections, which are approximately hemispherical at their free ends.

8. A device according to claim 1, wherein the blank region of the sleeve surface is located so that, in use, it corresponds to the central region of the underside of the wearer's finger tip.

9. A device according to claim 1, wherein the arrangement of raised elements comprises two groups each of at least one raised element, the two groups being spaced apart circumferentially around the sleeve surface by the blank region.

10. A device according to claim 9, wherein each of the two groups of raised elements comprises a row of two or more raised elements running parallel or approximately parallel to the longitudinal sleeve axis.

11. A device according to claim 1, wherein the raised element(s) at least partly define a fluid retaining region on the outer sleeve surface.

12. A device according to claim 11, wherein the fluid retaining region takes the form of an open-topped enclosure bound by the raised element(s) and the outer sleeve surface.

13. A device according to claim 11, wherein the sleeve surface in the fluid retaining region is substantially flat.

14. A device according to claim 11, wherein the fluid retaining region occupies the entire area within the loop formed by the raised element(s).

15. A device according to claim 11, wherein there are both primary and secondary raised elements on the outer sleeve surface, the secondary raised elements being positioned between primary raised elements but protruding less far above the sleeve surface, the arrangement being such that the primary and secondary elements together define a continuous fluid retaining wall.

16. A device according to claim 1, wherein at least one region of the sleeve has a greater flexibility than that of the rest of the sleeve and is able to stretch to allow an increase in the sleeve circumference.

17. A device according to claim 16, wherein the higher flexibility region is formed from the same material as that of the rest of the sleeve, but with a lower thickness.

18. A device according to claim 16, wherein the higher flexibility region is located, in use, at or near the side of the wearer's finger.

19. A device according to claim 16, wherein the higher flexibility region has an elongate shape and is orientated, in use, substantially in the direction of the wearer's finger.

20. A device according to claim 16, wherein the sleeve has two or more higher flexibility regions spaced radially around the sleeve.

21. A device according to claim 1, wherein the sleeve has a tearable portion which may be torn away, either partially or completely, from the rest of the sleeve and which is defined at least partly by a region of reduced sleeve strength.

22. A device according to claim 21, wherein the region of reduced sleeve strength is formed by a boundary between two sleeve regions of differing flexibility, thickness and/or strength.

23. A device according to claim 21, wherein the region of reduced sleeve strength is formed by a region of lower thickness than that of adjacent sleeve regions.

24. A device according to claim 1, wherein the sleeve is provided with a vent to facilitate the release of air from within during fitting.

25. A device according to claim 1, comprising one or more fluid cells which contain a substance to be delivered using the device and which are adapted to release the substance during use of the device.

26. A device according to claim 25, wherein the substance to be delivered comprises a lubricant and/or a pharmaceutically active substance.

27. A device according to claim 1, which is adapted for a single use and to be disposable after use.

28. A device according to claim 1, wherein the sleeve has sufficient rigidity to retain an approximately finger-shaped structure unsupported, yet can flex with the wearer's finger in use.

29. A device according to claim 1, wherein the sleeve is of a size sufficient to accommodate only the tip of the wearer's finger, being the finger end region bounded by the distal finger joint.

30. A device according to claim 1, wherein the circumference of the sleeve varies along its length, being greater at the position which corresponds, in use, to the wearer's proximal finger joint and smaller at the distal joint position.

31. A device of use in applying a tactile stimulus, the device comprising a sleeve adapted to accommodate a finger and one or more raised elements on the outer surface of the sleeve, wherein at least one region of the sleeve has a greater flexibility than that of the rest of the sleeve, so as to provide variability in the sleeve circumference.

32. (canceled)

33. A package containing a device according to claim 1, together with a substance to be delivered using it and instructions for using the device to apply the substance to a surface simultaneously with tactile pressure.

34. Use of a device according to claim 1, to apply tactile pressure to a surface.

35. Use of a device according to claim 1, to apply a fluid substance to a surface.

36. Use according to claim 34, wherein the surface comprises living tissue.

37. A method of treating female orgasmic disorder or a related condition, which method comprises applying a tactile stimulus to the genital area of a patient using a device according to claim 1, and optionally also applying, using the device, a lubricant and/or an active substance to the stimulated area.

38. (canceled)
